(19) United States
(12) Patent Application Publication
(10) Pub. No.: US 2012/0276480 A1
(43) Pub. Date: Nov. 1, 2012

(54) METHOD OF PREPARING POLYMERIZED TONER

(75) Inventors: Wook Jang, Daejeon (KR); Chang-Soon Lee, Daejeon (KR); Woo-Cheul Jung, Ulsan (KR)

(73) Assignee: LG CHEM, LTD., Seoul (KR)

(21) Appl. No.: 13/504,675

(22) PCT Filed: Oct. 28, 2010
(86) PCT No.: PCT/KR10/07473

§ 371 Date: Jul. 9, 2012

(30) Foreign Application Priority Data
Oct. 28, 2009 (KR) 10-2009-0102639

(51) Int. Cl. G03G 9/16

(52) U.S. Cl. 430/115; 430/137.15

(57) ABSTRACT

This present invention relates to a method of preparing a polymerized toner, which comprises the steps of: preparing an aqueous dispersion medium containing calcium phosphate; preparing a monomer mixture including a styrene-based pigment stabilizer having a weight average molecular weight of 2,000 to 200,000, a charge control agent, a pigment, and a monomer for binder resin; dispersing the monomer mixture in the form of droplets in the aqueous dispersion medium; and performing suspension polymerization for the monomer mixture dispersed in the form of droplets, and calcium phosphate is used in an amount of 2 to 6 parts by weight based on 100 parts by weight of the monomer mixture. Also, a polymerized toner produced using this method is provided.

### TECHNICAL FIELD

The present invention relates to a method of preparing a polymerized toner, and more particularly to a method of preparing a polymerized toner in which suspension polymerization is performed using calcium phosphate as an aqueous dispersion stabilizer and using a polymer pigment stabilizer having a predetermined molecular weight range, thus achieving a narrow particle size distribution, high transfer efficiency, and uniform images.

### BACKGROUND ART

Toners are used in electrophotographic development and electrostatic printers, duplicators, etc., and are referred to as a paint which may be transferred and fixed onto a target to form a desired pattern. Recently, as document preparation using a computer has been generalized, the demand for imaging devices such as printers is drastically increasing, and thus the use of toners is also increasing.

Generally, toner production methods are classified into a production method using pulverization and a production method using polymerization. The production method using pulverization, which is very widely known, is conducted by subjecting a resin and a pigment to a series of procedures of melting-mixing or extrusion, pulverization, and sorting, thus obtaining toner particles. However, the toner particles thus manufactured have a wide particle size distribution, and a very irregular shape such as pointed corners, undesirably resulting in poor chargeability or flowability.

To solve such problems, methods of manufacturing spherical toner particles using polymerization have been proposed. Examples of the methods of manufacturing a toner using polymerization are known to be emulsion polymerization (agglomeration) and suspension polymerization. Because with emulsion polymerization it is difficult to control the particle size distribution and may be problematic in terms of quality reproduction of the resultant toner, toner production using suspension polymerization is more preferably employed.

Toners resulting from suspension polymerization are obtained by dispersing a monomer mixture in the form of droplets in an aqueous dispersion medium via homogenization and then polymerizing it. In this procedure, however, it is difficult to manufacture particles having a narrow particle size distribution. Furthermore, only when the toner particles produced using suspension polymerization have very uniform chargeability can high transfer efficiency and uniform images be obtained.

Thus, there is a need for research and development into a process of manufacturing a polymerized toner in which a toner having a narrow particle size distribution may be effectively manufactured, and particularly which may achieve high transfer efficiency and uniform images.

### DISCLOSURE

### Technical Problem

Accordingly, the present invention is intended to provide a method of effectively preparing a polymerized toner which may achieve a narrow particle size distribution, high transfer efficiency, and uniform images.

### Technical Solution

The present invention provides a method of preparing a toner, which comprises the steps of: preparing an aqueous dispersion medium containing calcium phosphate; preparing a monomer mixture comprising a styrene-based pigment stabilizer having a weight average molecular weight of 2,000 to 200,000, a charge control agent, a pigment, and a monomer for binder resin; dispersing the monomer mixture in the form of droplets in the aqueous dispersion medium; and performing suspension polymerization for the monomer mixture dispersed in the form of droplets, and calcium phosphate is used in an amount of 2 to 6 parts by weight based on 100 parts by weight of the monomer mixture.

In addition, the present invention provides a polymerized toner prepared by the above method.

Hereinafter, the present invention is described in detail.

The present inventors found that, upon toner production using suspension polymerization, the optimal amount of calcium phosphate may be used as an aqueous dispersion stabilizer and a polymer compound having a predetermined molecular weight range may be used as a pigment stabilizer, thus ensuring dispersion stability and suspension polymerization stability and increasing stability of the pigment of the produced toner particles to thereby enhance charging characteristics to achieve high transfer efficiency and uniform images, which culminated in the present invention.

Particularly, a typical suspension polymerization process for a polymerized toner may be applied in the present invention, provided that upon preparation of an aqueous dispersion medium, calcium phosphate is used as a dispersion stabilizer, and a styrene-based compound having a weight average molecular weight of 2,000 to 200,000 may be used as a pigment stabilizer and a charge control agent.

According to a typical suspension polymerization process, a pigment, a charge control agent, wax, and so on are dissolved or dispersed in a monomer for binder resin to prepare a monomer mixture. The mixture is dispersed in an aqueous dispersion medium using a stirrer to form fine monomer mixture droplet particles, which are then heated to perform suspension polymerization, thus obtaining a toner having a desired particle size.

In the present invention, calcium phosphate is adopted as the dispersion stabilizer of the aqueous dispersion medium in such a suspension polymerization process thus ensuring superior dispersion stability, and the styrene-based compound having a predetermined molecular weight range is used as the pigment stabilizer so that the resulting toner particles are imparted with superior pigment stability, and suspension polymerization stability is ensured and chargeability is enhanced, thus preparing a polymerized toner having high transfer efficiency and superior image uniformity.

The method of preparing the toner according to the present invention comprises the steps of: preparing the aqueous dispersion medium containing calcium phosphate, preparing the monomer mixture comprising a styrene-based pigment stabilizer having a weight average molecular weight of 2,000 to 200,000, a charge control agent, a pigment, and a monomer for binder resin, dispersing the monomer mixture in the form of droplets in the aqueous dispersion medium, and performing suspension polymerization for the monomer mixture dispersed in the form of droplets, and calcium phosphate is used in an amount of 2 to 6 parts by weight based on 100 parts by weight of the monomer mixture.

In accordance with this method for preparing a toner, the monomer mixture comprising the monomer for binder resin, the charge control agent, the pigment, and the pigment stabilizer is added to the aqueous dispersion medium containing calcium phosphate and is thus dispersed in the form of fine droplets, after which such a dispersion solution is subjected to suspension polymerization. When such polymerization is carried out, the monomer mixture in the form of fine droplets is polymerized to form toner particles, thereby obtaining a polymerized toner as desired in the present invention.

Moreover, the present inventors conducted many experiments to ensure that the use of calcium phosphate which is the dispersion stabilizer, the amount of which is optimized into the ranges of 2 to 6 parts by weight based on 100 parts by weight of the monomer mixture, and also of the styrene-based compound having a weight average molecular weight of 2,000 to 200,000 as the pigment stabilizer, may result in a narrow particle size distribution with a uniform particle size, high transfer efficiency, and uniform images.

Respective steps of the method for preparing a toner according to the present invention are specified below.

First, the aqueous dispersion medium containing calcium phosphate is formed, and the monomer mixture comprising the styrene-based pigment stabilizer having a weight average molecular weight of 2,000 to 200,000, the pigment, the charge control agent, and the monomer for binder resin is formed, after which the monomer mixture is added to the aqueous dispersion medium and thus dispersed in the form of droplets. As such, the aqueous dispersion medium for dispersing the monomer mixture may be obtained by dissolving a dispersion stabilizer in water, and in the present invention, calcium phosphate is used as the dispersion stabilizer so that the monomer mixture may be maintained in a state of being stably dispersed in the aqueous medium.

As mentioned above, calcium phosphate that is useful in the present invention functions as a dispersion stabilizer for a polymerizable monomer composition in the aqueous dispersion medium.

Typically useful as the dispersion stabilizer is an inorganic dispersion stabilizer, examples of which include calcium phosphate, hydroxyapatite, magnesium phosphate, aluminum phosphate, zinc phosphate, calcium carbonate, magnesium carbonate, calcium hydroxide, magnesium hydroxide, aluminum hydroxide, meta-calcium silicate, calcium sulfate, barium sulfate, bentonite, silica, and alumina. Furthermore, examples of an organic dispersion stabilizer include polyvinyl alcohol, gelatin, methyl cellulose, methyl hydroxypropyl cellulose, ethyl cellulose, carboxyl methyl cellulose and sodium salts thereof, polyacrylic acid and salts thereof, and starch.

In the toner production using suspension polymerization, such a dispersion stabilizer is dispersed in an aqueous system before use. This dispersion stabilizer prevents the aggregation of polymerizable monomer composition particles which are uniformly dispersed in the aqueous medium and are present as droplets, and also seems to be uniformly adsorbed onto the surface of the droplets to stabilize the droplets. The dispersion stabilizer is solubilized using acid or alkali treatment or warm-water washing after completion of the polymerization of the polymerizable monomer in the droplets, and is then separated from the toner particles.

However, most of the compounds which may be used as the dispersion stabilizer are difficult to completely remove from the surface of toner particles depending on the properties thereof such as solubility, molecular weight, viscosity, etc. Also, upon strong alkali treatment, warm-water washing, etc., part of a coloring agent or a charge control agent may decompose or dissolve or heat denaturation may occur depending on the composition of the toner particles, undesirably damaging surface properties, friction chargeability or the like of the toner particles and drastically lowering developability of the toner. On the other hand, because the particles may strongly aggregate in the inorganic dispersion stabilizer, the viscosity may vary during the polymerization of the droplets thus lowering stability of the droplets, undesirably promoting destabilization such as aggregation of the droplets. Hence, it is not easy to select the dispersion stabilizer.

Therefore, in the present invention, calcium phosphate is used as the aqueous dispersion stabilizer to solve the above destabilization problems, and this may be easily removed from the surface of the toner particles only using acid treatment and/or water washing, thereby imparting superior dispersion stability upon production of a polymerized toner. In particular, because this may be effectively removed using only acid treatment or washing, decomposition or dissolution of a coloring agent or a charge control agent does not take place and there is no need to take heat denaturation into consideration.

In the present invention the term calcium phosphate is referred to as one or more selected from among calcium phosphate, calcium hydrogen phosphate, monocalcium phosphate, hydroxyapatite, and mixtures thereof. Taking the crystal size thereof, particle size of crystalline aggregates, and acid solubility into consideration, hydroxyapatite and calcium phosphate are preferable. Particularly useful is hydroxyapatite.

In a preferred embodiment of the present invention, calcium phosphate is produced in an aqueous medium from a phosphate aqueous solution and a calcium salt aqueous solution. The use of calcium phosphate produced in the aqueous medium in this way does not generate aggregates and may form uniform particulate crystals, thus attaining more preferable effects as the dispersion stabilizer and a stable suspension phase. Especially the case where powdery calcium phosphate is used unchanged makes it easy to form strong powder aggregates, which have a non-uniform particle size and are difficult to disperse in the aqueous medium. Hence, calcium phosphate is preferably used by being produced in the aqueous medium as mentioned above.

Also, to produce calcium phosphate in the aqueous medium, a sodium phosphate aqueous solution is preferably used as pHosphate aqueous solution, and a calcium chloride aqueous solution is preferably used as the calcium salt aqueous solution. As such, the sodium phosphate aqueous solution preferably has pH 4 to 7. Especially, to obtain spherical toner particles, pH of a mixture comprising phosphate aqueous solution and the calcium salt aqueous solution is preferably adjusted to 4.5 to 5.5.

Specifically, the method for preparing a toner according to the present invention may further comprise adding an acid such as hydrochloric acid, nitric acid, or sulfuric acid to pHosphate aqueous solution and then adding the calcium salt aqueous solution thereto, so that pH of the aqueous dispersion medium is adjusted to 4 to 7, and preferably 4.5 to 5.5.

Such calcium phosphate is used in an amount of 2 to 6 parts by weight, preferably 2.5 to 5 parts by weight, and more preferably 2.5 to 4 parts by weight, based on 100 parts by weight of the monomer for binder resin. As such, the amount of calcium phosphate may be set to 2 parts by weight or more to stably maintain the particles during the polymerization reaction, and may also be set to 6 parts by weight or less to prevent the formation of small particles in the course of homogenizing the monomer mixture.

When the polymerized toner is manufactured using the aqueous dispersion medium containing calcium phosphate in this way, the produced toner particles are in a state of calcium phosphate being adsorbed onto the surface thereof, and thus the toner particles are recovered in such a manner that pH of the aqueous dispersion medium containing the produced toner particles is adjusted to 2 or less, and preferably 1.5 or less, and then calcium phosphate is completely dissolved. This water washing process is repeated and drying is performed, thus obtaining final toner particles.

As mentioned above, the use of calcium phosphate as the aqueous dispersant facilitates pH of the aqueous dispersion solution to be adjusted to a neutral or acidic range so as to provide a force able to move to the surface of the toner particles due to electrostatic attraction of the charge control agent which is negatively charged. If the amount of calcium phosphate is less than 2 parts by weight based on 100 parts by weight of the monomer mixture, it does not satisfy the requirement of stabilizing monomer mixture droplets, undesirably causing fusion of the particles during the polymerization. In contrast, if the amount thereof is above 6 parts by weight based on 100 parts by weight of the monomer mixture, small particles may be formed in the course of homogenizing the monomer mixture.

As such, calcium phosphate has solubility depending on pH, and specifically, it is rapidly solubilized in the acidic range at low pH on the basis of pH 1.5 to 2.5, and is completely solubilized in the strong acidic range of pH 1.5 or less. In order to completely remove the dispersion stabilizer particles from the toner particles, acid treatment may be carried out at pH 2.0 or less, and preferably pH 1.5 or less. Such acid treatment does not cause the decomposition, dissolution and denaturation of the other components of the toner composition, for example, a coloring agent, a charge control agent, etc., unlike alkali treatment, and has no additional influences on the characteristics of the toner.

Also, in the present invention, the styrene-based pigment stabilizer having a weight average molecular weight of 2,000 to 200,000 is used, as well as the aqueous dispersion medium containing calcium phosphate as mentioned above.

Typically, the pigment stabilizer is known to be a low-molecular-weight surfactant, and specific examples of the conventional pigment stabilizer include polyol or non-ionic surfactants. However, when the conventional low-molecular-weight surfactant is used as the pigment stabilizer, fine particles may be easily formed in the course of homogenizing a pigment mixture in the aqueous dispersion solution. Even if a polymer pigment stabilizer is used, only when a component having affinity to both a pigment and a monomer is added can the pigment be uniformly dispersed in the toner particles without intensive distribution.

Useful as the pigment stabilizer in the present invention is a styrene-based compound having a weight average molecular weight of 2,000 to 200,000, preferably 10,000 to 150,000, and more preferably 20,000 to 100,000, thus exhibiting superior stability, remarkably enhancing compatibility with the pigment, and solving problems of the pigment being concentrated onto the surface of the toner, which decrease chargeability and charging stability. Specifically, the weight average molecular weight of the styrene-based pigment stabilizer may be set to 2,000 or more to ensure superior stability in the toner particles and optimize compatibility with the binder resin, and may also be set to 200,000 or less to maintain the surface concentration adapted for effective functions as the pigment stabilizer and maintain the optimal viscosity of the monomer mixture. The case where the weight average molecular weight of the styrene-based pigment stabilizer exceeds 200,000 is disadvantageous because the viscosity of the monomer mixture becomes too high thus aggravating dispersion stability and polymerization stability, ultimately widening the particle size distribution.

Furthermore, in the present invention, the pigment stabilizer preferably includes a styrene-based block copolymer. When the styrene-based block copolymer is used as the pigment stabilizer, it enables the pigment to be uniformly dispersed in the monomer and also in the toner particles after polymerization because of good affinity to both the pigment and the monomer, thus solving problems of low chargeability as a result of the pigment being intensively distributed onto the surface of the toner. When charging characteristics are improved and become uniform in this way, the polymerized toner has a narrow particle size distribution and may achieve high transfer efficiency and uniform images.

The pigment stabilizer of the present invention may be one or more copolymers selected from among triblock copolymers, such as styrene-butadiene-styrene (SBS), styrene-isoprene-styrene (SIS), styrene-ethylene-styrene (SES), styrene-ethylene-butylene-styrene (SEBS), styrene-ethylene-propylene-styrene (SEPS), etc., and styrene-based diblock or triblock copolymers such as styrene-butadiene (SB), styrene-isoprene (SI), styrene-ethylene-butylene (SEB), styrene-ethylene-propylene (SEP), and so on. The pigment stabilizer may be selected depending on the structure of specific pigment component. For example, when carbon black having a network structure of benzene rings is used as the pigment, styrene-butadiene-styrene (SBS) having double bonds is favorably used.

The styrene-based pigment stabilizer may be used in an amount of 0.1 to 20 parts by weight, and preferably 0.5 to 5 parts by weight based on 100 parts by weight of the monomer mixture for binder resin. Specifically, the amount of the styrene-based pigment stabilizer may be set to 0.1 parts by weight or more to expect improvements in dispersibility of the pigment, and may also be set to 20 parts by weight or less taking into consideration an increase in the viscosity of the pigment mixture.

As mentioned above, the feature of the present invention is that suspension polymerization is performed using calcium phosphate as the aqueous dispersion stabilizer and using the styrene-based pigment stabilizer having a predetermined molecular weight range. Furthermore, the styrene-based pigment stabilizer enables the pigment to be uniformly distributed in the toner particles thus preventing charging characteristics of the toner particles from decreasing as a result of the pigment being intensively distributed onto the surface of the toner. However, when the styrene-based pigment stabilizer is not used together with the calcium phosphate dispersant, toner particles having a wide particle size distribution may be formed during homogenization and polymerization in the suspension polymerization process, and such a wide particle size distribution may cause the printing transfer efficiency to decrease. Accordingly, when the styrene-based pigment stabilizer is used alone without the calcium phosphate dispersant, sorting for filtering small toner particles has to be inevitably carried out to narrow the particle size distribution of the toner particles.

Separately from the styrene-based pigment stabilizer, in the case where only the calcium phosphate dispersant is used, the pigment may be intensively distributed onto the surface of the toner, thus deteriorating the charging characteristics of the toner particles, undesirably lowering printing transfer efficiency and forming non-uniform images. The intensive distribution of the pigment onto the surface of the toner particles is considered to be due to the charge control agent having anions, which is physically and chemically combined with the pigment in the pigment mixture. More specifically, when homogenizing is performed in the presence of the calcium phosphate dispersant, the aqueous solution is acidic and thus the charge control agent moves to the surface of the toner particles due to electrostatic attraction with cations outwards of the particles. As such, the pigment which is physically and chemically combined with the charge control agent is considered to move together toward the surface of the toner particles. Thus, in the present invention, the styrene-based pigment stabilizer having a predetermined molecular weight range is used along with the calcium phosphate dispersant, whereby the pigment is uniformly distributed in the toner particles and also a decrease in transfer efficiency or formation of non-uniform images as a result of charging characteristics of the surface of the toner particles being deteriorated may be prevented. Furthermore, according to the present invention, it is possible to produce a toner having superior transfer efficiency even without performing additional sorting, thanks to the uniform particle size distribution.

Meanwhile in the present invention, the monomer for binder resin may include any monomer which may be used in toners which are prepared using polymerization, and is not particularly limited. Examples of the monomer may include a styrene-based monomer, an acrylate-based monomer, a methacrylate-based monomer, or a diene-based monomer, which may be used in mixtures of one or more. Also, this monomer may be further mixed with one or more selected from among acidic and basic olefin monomers.

In a more preferred embodiment of the present invention, the monomer includes (a) a styrene-based monomer and (b) one or more selected from among an acrylate-based monomer, a methacrylate-based monomer, and a diene-based monomer. Based on 100 parts by weight of the total of the monomers (a) and (b), the (a) styrene-based monomer is used in an amount of 30 to 95 parts by weight, and the (b) one or more selected from among an acrylate-based monomer, a methacrylate-based monomer and a diene-based monomer may be used in an amount of 5 to 70 parts by weight. Also, (c) one or more selected from among an acidic olefin monomer and a basic olefin monomer may be further added to the above monomer composition in an amount of 0.1 to 30 parts by weight based on 100 parts by weight of the total of the monomers (a) and (b).

An aromatic vinylic monomer may include styrene, monochlorosytrene, methylstyrene, dimethylstyrene, etc., and may be used in an amount of 30 to 95 parts by weight and preferably 50 to 80 parts by weight, based on the total of the monomers.

The acrylate-based monomer may include methylacrylate, ethylacrylate, n-butylacrylate, isobutylacrylate, dodecylacrylate, 2-ethylhexylacrylate, etc., the methacrylate-based monomer may include methyl methacrylate, ethyl methacrylate, n-butyl methacrylate, isobutyl methacrylate, dodecyl methacrylate, 2-ethylhexyl methacrylate, etc., and the diene-based monomer may include butadiene, isoprene, etc. The one or more selected from among the acrylate-based monomer, the methacrylate-based monomer, and the diene-based monomer may be used in an amount of 5 to 70 parts by weight and preferably 20 to 50 parts by weight based on the total of the monomers.

The acidic olefin monomer may include an α,β-ethylenically unsaturated compound having a carboxylic group, etc., and the basic olefin monomer may include an amine group- or a quaternary ammonium group-containing aliphatic alcoholic methacrylic acid ester, methacryl amide, vinyl amine, diallyl amine, or ammonium salts thereof. Specifically, one or more selected from among the acidic and basic olefin monomers may be used in an amount of 0.1 to 30 parts by weight, and preferably 0.2 to 10 parts by weight based on the total of the monomers.

Also, one or more polar polymers selected from among a polyester polymer and a styrene acrylic polymer may be further added in an amount of 0.01 to 10 parts by weight and preferably 0.1 to 8 parts by weight based on 100 parts by weight of the monomers.

The present invention includes adding the charge control agent and the pigment to the styrene-based pigment stabilizer having a weight average molecular weight of 2,000 to 200,000 and the binder resin monomer to prepare the monomer mixture.

The charge control agent may include a cationic charge control agent, an anionic charge control agent, and mixtures thereof. Examples of the cationic charge control agent includes nigrosin-type electron accepter pigments, higher aliphatic metal salts, alkoxyamine, chelates, quaternary ammonium salts, alkylamide, fluorinated activators, metal salts of naphthalenic acid, etc. Examples of the anionic charge control agent may include electron accepter organic complexes, chlorinated paraffin, chlorinated polyester, an excess of acid-containing polyester, sulfonylamine of copper phthalocyanine, polymers having a sulfonic acid group, etc.

To improve stability as the charge control agent and compatibility with the binder resin and to minimize a decrease in chargeability, a polymer having a weight average molecular weight of 10,000 to 20,000, preferably 12,000 to 19,000, and more preferably 14,000 to 18,000 may be used. Preferably useful is a styrene-acrylic polymer having a sulfonic acid group. As such, in the case of using the charge control agent having a copolymeric structure of a polymer having a sulfonic acid group, a decrease in charge control characteristics due to surface concentration of the pigment and adsorption may be effectively removed thus preventing the obstruction of charging characteristics by the pigment. When the charging characteristics are improved and become uniform in this way, the polymerized toner may further impart effects of high transfer efficiency and uniform imaging while having a narrow particle size distribution.

The charge control agent functions to stabilize the particles during the suspension polymerization, along with the dispersion stabilizer. When the molecular weight of the charge control agent is above 20,000, the charge control agent does not move to the surface of the particles, thus causing the particles to be fused during suspension polymerization. In contrast, if the molecular weight thereof is less than 10,000, small particles may be feasibly generated in the course of homogenizing the monomer mixture.

The charge control agent may be used in an amount of 0.1 to 20 parts by weight, preferably 0.2 to 10 parts by weight, and more preferably 0.6 to 5 parts by weight based on 100 parts by weight of the monomer mixture. The amount of the charge control agent may be set to 0.1 parts by weight or more in terms of dispersion stability, and may also be set to 20 parts by weight or less in terms of suppressing the generation of powder.

The pigment may include any pigment suitable for polymerized toners, and examples thereof include a metal powder-type pigment, a metal oxide-type pigment, a carbon-type pigment, a sulfide-type pigment, a chromium salt-type pigment, a ferrocyanide-type pigment, an azo-type pigment, an acidic dye-type pigment, a basic dye-type pigment, a mordant dye-type pigment, phthalocyanine, a quinacridone-type pigment, and a dioxane-type pigment, which may be used alone or in combinations of two or more thereof. In the present invention, the pigment may be used in an amount of 1 to 10 parts by weight and preferably 2 to 8 parts by weight based on 100 parts by weight of the monomer mixture.

Upon forming the monomer mixture, wax may be further added, in addition to the pigment, the charge control agent, and the monomer component for binder resin. The wax may include paraffin wax, microcrystalline wax, ceresin wax, carnauba wax, ester-based wax, polyethylene-based wax, or polypropylene-based wax, which may be used alone or in combinations of two or more thereof. In the present invention, the wax may be used in an amount of 0.1 to 30 parts by weight based on 100 parts by weight of the monomer mixture.

The monomer mixture may further include one or more additives selected from the group consisting of a reaction initiator, a crosslinking agent, a lubricating agent (e.g. oleic acid, stearic acid, etc.), a molecular weight control agent, and a coupling agent.

The reaction initiator may include an oil-soluble initiator and a water-soluble initiator. Specific examples thereof include an azo-based initiator such as azobisisobutyronitrile, azobisvaleronitrile, etc.; an organic peroxide such as benzoyl peroxide, lauroyl peroxide, etc.; and a water-soluble initiator such as potassium persulfate, ammonium persulate, etc., which may be used alone or in combinations of two or more thereof. The reaction initiator may be used in an amount of 0.1 to 10 parts by weight and preferably 1 to 5 parts by weight based on 100 parts by weight of the total of the monomers.

The crosslinking agent may include one or more selected from among divinylbenzene, ethylene dimethacrylate, ethyleneglycol dimethacrylate, diethyleneglycol diacrylate, 1,6-hexamethylene diacrylate, allyl methacrylate, 1,1,1-trimethylolpropane triacrylate, triallylamine, and tetraallyloxyethane, and may be used in an amount of 0.001 to 10 parts by weight based on 100 parts by weight of the total of the monomers.

The molecular weight control agent may include one or more selected from among t-dodecyl mercaptan, n-dodecyl mercaptan, n-octyl mercaptan, carbon tetrachloride, and carbon tetrabromide, and may be used in an amount of 0.001 to 8.000 parts by weight based on 100 parts by weight of the total of the monomers.

As the lubricating agent and the coupling agent, all additives which are known to be usable in the monomer mixture to produce a polymerized toner may be used in appropriate amounts.

In the present invention, the monomer mixture comprising the pigment stabilizer, the charge control agent, the pigment and the monomer, and optionally some additives, may be formed.

The monomer mixture is added to the aqueous medium, after which the monomer mixture in the aqueous medium is uniformly dispersed in the form of fine droplets. Final toner particles are formed from the monomer mixture in the form of fine droplets. To carry out the dispersion in the form of fine droplets, a shear force is applied to the monomer mixture and the aqueous dispersion medium using a homogenizer so that homogenization is performed. For example, the mixed solution is homogenized at a rate of 5,000 to 20,000 rpm, and preferably 8,000 to 17,000 rpm using a homogenizer, whereby the monomer mixture is dispersed in the form of fine droplets in the aqueous dispersion medium.

Specifically, a homogenizing process is carried out in such a manner that a shear force is applied to a mixture comprising 100 parts by weight of the aqueous dispersion solution and 1 to 60 parts by weight and preferably 10 to 40 parts by weight of the monomer mixture using a homogenizer so that the monomer mixture is dispersed in the form of fine droplets in the aqueous dispersion solution.

Then, the monomer mixture dispersed in the form of droplets is subjected to suspension polymerization. During such suspension polymerization, the polymerizable monomer or the like is polymerized in a state of being dispersed in the form of fine droplets, thus forming a predetermined polymer or copolymer. Thereby, toner particles composed mainly of the polymer or copolymer thus formed may be provided. Upon forming the toner particles, suspension polymerization may be carried out at 60 to 90° C. for 8 to 20 hr, thereby appropriately forming the polymerized toner having a uniform particle size distribution.

After the formation of the toner particles using suspension polymerization, washing the toner particles to remove calcium phosphate and drying the toner particles may be further performed, whereby a polymerized toner according to another embodiment of the present invention may be prepared.

To remove the calcium phosphate, a water-soluble inorganic acid is added to the dispersion solution containing the toner particles in terms of the solubility of calcium phosphate depending on pH, so that pH of the solution is adjusted to 2 or less and preferably 1.5 or less. Thereby, the dispersion stabilizer is dissolved in an aqueous solution and thus removed from the toner particles. After removal of the dispersion stabilizer in this way, dewatering using a filter, dilution using an excess of distilled water, and dewatering may be repeated several times.

The resulting toner cake is then placed in a vacuum oven, and dried in a vacuum at room temperature to produce a pressure fixing toner.

Additionally, the surface of the toner may be coated with an external additive, for example silica or the like, if necessary. This coating with the external additive may be conducted by adding the external additive to the toner particles using a Henschel mixer and then performing high-speed stirring. Any silica may be used so long as it is usable in polymerized toners.

According to a further preferred embodiment of the present invention, the polymerized toner may be manufactured by preparing an aqueous dispersion medium containing calcium phosphate deposited from a mixture comprising a sodium phosphate aqueous solution and a calcium chloride aqueous solution, homogenizing the monomer mixture so that it is dispersed in the form of fine droplets in the aqueous dispersion medium, polymerizing the monomer mixture dispersed in the form of droplets, washing and drying the polymerized toner core, and coating the polymerized toner core with an external additive.

The method of preparing the polymerized toner according to the above preferred embodiment of the present invention is described in detail below.

(1) Preparing Polymerized Toner

An aqueous dispersion solution containing calcium phosphate deposited by mixing a 0.1 M sodium phosphate aqueous solution with a 1 M calcium chloride aqueous solution is prepared, and a monomer mixture is added to the aqueous dispersion solution and is then subjected to a shear force by a homogenizer so as to be homogenized whereby the monomer mixture is dispersed in the form of fine droplets, followed by performing polymerization, thus obtaining a toner core.

The monomer may include an aromatic vinylic monomer or an acrylate-based monomer, a methacrylate-based monomer, a diene-based monomer, or mixtures thereof, and selectively may further include an acidic or basic olefin monomer.

(2) Removing Calcium Phosphate and Drying

To remove calcium phosphate from the solution containing the polymerized toner thus formed, hydrochloric acid is added to the polymerized reaction solution so that pH of the solution is adjusted to be less than 2, thus completely dissociating calcium phosphate from the aqueous system. Distilled water is then added in an amount double the total weight of the solution to dilute the solution, after which a shear force is applied using a homogenizer, and separation and washing are performed using a filter, a filter press, a general centrifuge, a continuous decanter-type high-speed centrifuge, etc., so that calcium phosphate is completely removed from the polymer. Finally, filtering is performed to remove water, and the resulting toner cake is placed in a vacuum oven and dried in a vacuum at room temperature, thus producing a polymerized toner.

(3) Coating with External Additive

Silica is added to the polymerized toner core using a Henschel mixer, and the surface of the core is coated with an external additive with high-speed stirring at 5,000 rpm for 7 min.

On the other hand, the present invention provides a polymerized toner prepared by the above method. The polymerized toner is manufactured from the monomer mixture comprising the pigment stabilizer, the charge control agent, the pigment, and the monomer for binder resin, and specifically, based on 100 parts by weight of the total amount of the polymerized toner, 0.1 to 20 parts by weight and preferably 0.5 to 10 parts by weight of a styrene-based pigment stabilizer having a weight average molecular weight of 2,000 to 20,000, 0.1 to 20 parts by weight and preferably 0.2 to 10 parts by weight of a charge control agent, 1 to 10 parts by weight and preferably 2 to 8 parts by weight of a pigment, and 0 to 30 parts by weight and preferably 0.1 to 30 parts by weight of wax, may be included. As such, based on 100 parts by weight of the monomer for binder resin, one or more selected from among 0.03 to 10 parts by weight of a reaction initiator, 0.003 to 15 parts by weight of a crosslinking agent, and 0.003 to 12 parts by weight of a molecular weight control agent may be further added, if necessary.

Also, the surface of the toner particles thus prepared corresponding to the toner core as mentioned above may be coated with silica or the like.

The polymerized toner according to the present invention has superior properties which enable a narrow particle size distribution, high transfer efficiency, and uniform imaging, and furthermore, it has a volume average particle size of 7.0 to 8.5 μm (micrometer), and a standard deviation of 1.3 or less corresponding to a ratio of volume average particle size and number average particle size, and transfer efficiency of 95% or more. Upon measuring image uniformity, a difference in image concentration between the corner portions and the center portion of printing paper is 0.05 or less thus obtaining very superior image uniformity.

In the present invention, contents other than the above description may be added or subtracted it necessary, and are not particularly limited.

### Advantageous Effects

According to the present invention, an optimal amount of calcium phosphate is used as an aqueous dispersion stabilizer and a styrene-based pigment stabilizer having a predetermined molecular weight range is used to perform suspension polymerization, thus effectively producing a toner having a narrow particle size distribution, improved pigment stability in the toner particles and superior charging characteristics.

Furthermore, the polymerized toner according to the present invention has a narrow particle size distribution, thus making it easy to control the toner particle size distribution, and considerably facilitating the reproduction of the quality of the prepared toner. Also, the polymerized toner can achieve high transfer efficiency and uniform images, thus exhibiting very good performance in electrophotographic development, etc.

### MODE FOR INVENTION

The following preferred examples, which are set forth to aid the understanding of the present invention, are merely illustrative but are not construed as limiting the scope of the present invention.

### EXAMPLE 1

### Preparation of Polymerized Toner

500 parts by weight of water was mixed with 686 parts by weight of a 0.1 M sodium phosphate aqueous solution and 100 parts by weight of 1 M calcium chloride thus preparing an aqueous dispersion medium in which calcium phosphate crystals were deposited in an aqueous solution phase, which was then heated to a reaction temperature of 70 □ (celsius temperature) and stirred for 20 min. The amount of calcium phosphate in the aqueous dispersion medium was controlled to 3 parts by weight based on 100 parts by weight of the following monomer mixture.

A monomer composition comprising 160 parts by weight of styrene, 36 parts by weight of n-butyl acrylate, and 4 parts by weight of acrylic acid was mixed with 4 parts by weight of allyl methacrylate as a crosslinking agent and 0.4 parts by weight of n-dodecyl mercaptan as a molecular weight control agent, further mixed with 3 parts by weight of a styrene-butadiene-styrene (SBS) block copolymer having a molecular weight of 10,000 as a pigment stabilizer and 1 part by weight of a styrene-acrylic copolymer (M.W.: 16,500) having a sulfonic acid group as a charge control agent, sufficiently dissolved, added with 10 parts by weight of a pigment and stirred at 2,000 rpm for 2 hr using a bead mill, followed by removing the beads, thereby finally preparing 225 parts by weight of a monomer-pigment mixture.

This mixture was heated to 70 □ in a water bath, added with 20 parts by weight of paraffin wax, and then stirred for 20 min, thus obtaining a monomer mixture, which was then homogenized with an aqueous dispersion medium by means of a homogenizer at 13,000 rpm, so that the monomer mixture was dispersed in the form of fine droplets in the aqueous dispersion medium, and stirred at 200 rpm using a paddle-type stirrer to allow it to react for 15 hr, thereby preparing a polymerized toner.

Washing with Centrifuge

Hydrochloric acid was added to the aqueous dispersion solution containing the polymerized toner thus synthesized to adjust pH less than 2 so that calcium phosphate was dissolved in an aqueous system, after which the dispersion solution was diluted with distilled water in an amount double the total weight thereof, followed by applying a shear force thereto using a homogenizer and then performing centrifugation using a centrifuge (Beckman J2-21 M, Rotor JA-14) at 3,000 rpm for 15 min. The concentrated solution containing the polymerized toner was further subjected twice to a series of procedures of dilution with distilled water in a double amount, application of shear force using a homogenizer, and then centrifugation using a centrifuge (Beckman J2-21 M, Rotor JA-14) at 3,000 rpm for 15 min, thereby removing calcium phosphate from the surface of the toner. Finally, filtering was conducted to remove water, after which the resulting toner cake was placed in a vacuum oven and dried in a vacuum at room temperature for 48 hr to prepare a polymerized toner core. The volume average particle size of the polymerized toner core was 7 μm (micrometer), and the ratio (standard deviation) of volume average particle size and number average particle size was 1.26.

Coating with External Additive

100 parts by weight of the polymerized toner core was mixed with 2 parts by weight of silica using a Henschel mixer, and was high-speed stirred at 5,000 rpm for 7 min, so that the surface of the polymerized toner core was coated with the external additive.

### EXAMPLE 2

A polymerized toner was preoared in the same manner as in Example 1, with the exception that the amount of calcium phosphate was 5 parts by weight based on 100 parts by weight of the monomer mixture.

### EXAMPLE 3

A polymerized toner was prepared in the same manner as in Example 1, with the exception that styrene-ethylene-styrene (SES) having a weight average molecular weight of 50,000 was used as the pigment stabilizer.

### EXAMPLE 4

A polymerized toner was prepared in the same manner as in Example 1, with the exception that styrene-isoprene-styrene (SIS) having a weight average molecular weight of 80,000 was used as the pigment stabilizer.

### EXAMPLE 5

A polymerized toner was prepared in the same manner as in Example 1, with the exception that styrene-butadiene (SB) having a weight average molecular weight of 80,000 was used as the pigment stabilizer.

### EXAMPLE 6

A polymerized toner was prepared in the same manner as in Example 1, with the exception that styrene-butadiene-styrene (SBS) having a weight average molecular weight of 80,000 was used as the pigment stabilizer.

### EXAMPLE 7

A polymerized toner was prepared in the same manner as in Example 1, with the exception that styrene-butadiene-styrene (SBS) having a weight average molecular weight of 120,000 was used as the pigment stabilizer.

### COMPARATIVE EXAMPLE 1

A polymerized toner was prepared in the same manner as in Example 1, with the exception that the pigment stabilizer was not used.

### COMPARATIVE EXAMPLE 2

A polymerized toner was prepared in the same manner as in Example 1, with the exception that styrene-butadiene-styrene (SBS) having a weight average molecular weight of 1,000 was used as the pigment stabilizer.

### COMPARATIVE EXAMPLE 3

A polymerized toner was prepared in the same manner as in Example 1, with the exception that styrene-butadiene-styrene (SBS) having a weight average molecular weight of 205,000 was used as the pigment stabilizer.

### COMPARATIVE EXAMPLE 4

A polymerized toner was prepared in the same manner as in Example 1, with the exception that calcium phosphate was not used.

### COMPARATIVE EXAMPLE 5

A polymerized toner was prepared in the same manner as in Example 1, with the exception that the amount of calcium phosphate was 1.5 parts by weight based on 100 parts by weight of the monomer mixture.

### COMPARATIVE EXAMPLE 6

A polymerized toner was prepared in the same manner as in Example 1, with the exception that the amount of calcium phosphate was 7 parts by weight based on 100 parts by weight of the monomer mixture.

### COMPARATIVE EXAMPLE 7

A polymerized toner was prepared in the same manner as in Example 1, with the exception that sodium lauryl sulfate having a weight average molecular weight of 288 which is a low-molecular-weight surfactant was used instead of the styrene-based block copolymer as the pigment stabilizer.

### COMPARATIVE EXAMPLE 8

A polymerized toner was prepared in the same manner as in Example 1, with the exception that PVA was used instead of calcium phosphate, as the dispersion stabilizer.

### COMPARATIVE EXAMPLE 9

A polymerized toner was prepared in the same manner as in Example 1, with the exception that colloidal silica was used instead of calcium phosphate, as the dispersion stabilizer.

### COMPARATIVE EXAMPLE 10

A polymerized toner was prepared in the same manner as in Example 1, with the exception that polyacrylate having a weight average molecular weight of 20,000, the chain of which was partially substituted with a fluoro-carbon or alkylamine, was used instead of the styrene-based block copolymer, as the pigment stabilizer.

### TEST EXAMPLE

The properties of the polymerized toners of Examples 1 to 7 and Comparative Examples 1 to 10 were evaluated as below.

Transfer Efficiency of Toner

The feeder of a cartridge of a laser printer (HP4600, available from Hewlett Packard) was filled with a surface-treated toner, and the total weight of the feeder was measured, after which a rectangular pattern having a width of 19 cm and a length of 1.5 cm was printed on 1000 sheets of A4 printing paper, after which the weight of the feeder was measured, and thus the amount of consumed toner was calculated according to the following Equation 1.

Consumed amount (g)=weight of feeder before printing of 1000 sheets−weight of feeder after printing of 1000 sheets [Equation 1]

Also, the weight of a drum that was separable from the feeder was measured before and after printing, and the amount of toner which was not transferred onto paper but was wasted was determined according to the following Equation 2.

Wasted toner amount (g)=weight of drum after printing of 1000 sheets−weight of drum before printing of 1000 sheets [Equation 2]

The consumed amount and the wasted amount of the toner were calculated as above, and the transfer efficiency was determined according to the following Equation 3.

Transfer efficiency (%)={(consumed amount−wasted toner amount)/consumed amount}×100 [Equation 3]

Image Uniformity

The entire surface of A4 printing paper was printed using a laser printer (HP2600, available from Hewlett Packard), and the image concentrations of four corner portions and one center portion of the printing paper were measured using an image concentration meter (RD918, Macbeth). Upon evaluation of image uniformity, the case where a difference in measured values is 0.05 or less is judged to be uniform, the case where a difference in measured values is 0.1 or less is judged to be fair, and the case where a difference in measured values exceeds 0.1 is judged to be non-uniform.

The results of evaluating average particle size, standard deviation, transfer efficiency, and image uniformity of the polymerized toners of Examples 1 to 7 and Comparative Examples 1 to 10 are given in Table 1 below.

TABLE 1

| | Dispersion | | | | | | | | |
|---|---|---|---|---|---|---|---|---|---|
| | Stabilizer | | Pigment Stabilizer | | | Polymerized Toner | | | |
| | | Amount | | | Amount | Average | | Transfer | |
| | | (wt | | | (wt | Particle | Standard | Efficiency | Image |
| No. | Component | parts) | Component | M.W. | parts) | Size (μm) | Deviation | (%) | Uniformity |
| Ex. 1 | Calcium | 3 | SBS | 10,000 | 3 | 7.5 | 1.26 | 97 | Uniform |
| | Phosphate | | | | | | | | |
| Ex. 2 | Calcium | 5 | SBS | 10,000 | 3 | 7.2 | 1.27 | 96 | Uniform |
| | Phosphate | | | | | | | | |
| Ex. 3 | Calcium | 3 | SES | 50,000 | 3 | 7.7 | 1.26 | 96 | Uniform |
| | Phosphate | | | | | | | | |
| Ex. 4 | Calcium | 3 | SIS | 80,000 | 3 | 7.9 | 1.27 | 97 | Uniform |
| | Phosphate | | | | | | | | |
| Ex. 5 | Calcium | 3 | SB/SI | 80,000 | 3 | 7.8 | 1.28 | 97 | Uniform |
| | Phosphate | | | | | | | | |
| Ex. 6 | Calcium | 3 | SBS | 80,000 | 3 | 8.0 | 1.27 | 98 | Uniform |
| | Phosphate | | | | | | | | |
| Ex. 7 | Calcium | 3 | SBS | 120,000 | 3 | 8.2 | 1.28 | 97 | Uniform |
| | Phosphate | | | | | | | | |
| C. Ex. 1 | Calcium | 3 | — | — | — | 7.1 | 1.27 | 96 | Non-uniform |
| | Phosphate | | | | | | | | |
| C. Ex. 2 | Calcium | 3 | SBS | 1,000 | 3 | 7.0 | 1.28 | 95 | Non-uniform |
| | Phosphate | | | | | | | | |
| C. Ex. 3 | Calcium | 3 | SBS | 205,000 | 3 | 9.5 | 1.29 | 90 | Non-uniform |
| | Phosphate | | | | | | | | |
| C. Ex. 4 | — | — | SBS | 10,000 | 3 | — | — | — | — |
| C. Ex. 5 | Calcium | 1.5 | SBS | 10,000 | 3 | 10.5 | 1.4 | 70 | Non-uniform |
| | Phosphate | | | | | | | | |
| C. Ex. 6 | Calcium | 7 | SBS | 10,000 | 3 | 10.5 | 1.45 | 60 | Non-uniform |
| | Phosphate | | | | | | | | |
| C. Ex. 7 | Calcium | 3 | Sodium Lauryl | 288 | 3 | 7.0 | 1.45 | 80 | Non-uniform |
| | Phosphate | | Sulfate | | | | | | |
| C. Ex. 8 | PVA | 3 | SBS | 10,000 | 3 | 7.5 | 1.40 | 80 | Non-uniform |
| C. Ex. 9 | Colloidal | 3 | SBS | 10,000 | 3 | 7.5 | 1.45 | 75 | Non-uniform |
| | Silica | | | | | | | | |
| C. Ex. | Calcium | 3 | Polyacrylate | 20,000 | 3 | 7.5 | 1.45 | 75 | Non-uniform |
| 10 | Phosphate | | | | | | | | |

As is apparent from Table 1, the polymerized toners of Examples 1 to 7 according to the present invention, in which an appropriate amount of calcium phosphate is used as the aqueous dispersion stabilizer and also the styrene-based pigment stabilizer having an appropriate molecular weight is used, had a volume average particle size of 7.2 to 8.2 μm (micrometer), a standard deviation of 1.26 to 1.28 corresponding to the ratio of volume average particle size and number average particle size, superior transfer efficiency of 96% or more, and very good image uniformity.

The polymerized toners of Examples 1 to 7 can be seen to be superior in terms of particle size distribution, transfer efficiency, and images compared to Comparative Examples 1 to 6 in which the molecular weight and the amount of the pigment stabilizer or the amount of calcium phosphate fall outside the ranges of the present invention, Comparative Examples 7 and 10 using the other pigment stabilizers instead of the styrene-based block copolymer, and Comparative Examples 8 and 9 using the other dispersion stabilizers instead of calcium phosphate.

Specifically, when the pigment stabilizer is not used, as in Comparative Example 1, a difference in image concentration between the corner portions and the center portion of the printing paper is 0.1 or more and thus non-uniform images are obtained. When the molecular weight of the pigment stabilizer is too small to the level of 1,000, as in Comparative Example 2, such non-uniform images may result. In contrast, when the molecular weight of the pigment stabilizer is too large to the level of 205,000 as in Comparative Example 3, the addition of the pigment stabilizer may increase the viscosity of the monomer mixture and the resulting toner has a very large average particle size of 9.5 μm (micrometer), and thus, upon applying this toner to the printer, the amount of consumed toner becomes excessive, and thus non-uniform images may be formed.

Meanwhile, when the dispersant is not used, as in Comparative Example 4, a coagulum of toner particles may be formed during polymerization, making it impossible to manufacture the toner able to evaluate an image. When calcium phosphate is used in amounts of 1.5 parts by weight and 7 parts by weight, as in Comparative Examples 5 and 6, respectively falling outside the optimal amount range, the standard deviations of the polymerized toners are 1.4 and 1.45, which means that the particle size distribution is wide, and furthermore, the transfer efficiency values are remarkably lowered to 70% and 60%, and non-uniform images are formed.

As in Comparative Examples 7 and 10, when the conventional low-molecular-weight surfactant, namely, sodium lauryl sulfate, and the high-molecular-weight modified polyacrylate are used as the pigment stabilizer, the standard deviations of the polymerized toners are 1.45, which means that the particle size distribution is wide, and furthermore, the transfer efficiency values are lowered to 80% and 75%, respectively, and non-uniform images are formed. In particular, when modified polyacrylate is used as the pigment stabilizer, as in Comparative Example 10, a large amount of powder may be generated, undesirably widening the particle size distribution and lowering the transfer efficiency. When conventional PVA and colloidal silica are used instead of calcium phosphate as the dispersant, as in Comparative Examples 8 and 9, respectively, the standard deviations of the polymerized toners are 1.40 and 1.45, which means that the particle size distribution is wide, and furthermore, the transfer efficiency values are lowered to 80% and 75%, and non-uniform images are formed.

As mentioned hereinbefore, according to the present invention, an optimal amount of calcium phosphate is used as the aqueous dispersant and a styrene-based block copolymer having a high molecular weight is used as the pigment stabilizer, thereby manufacturing the polymerized toner which has a narrow particle size distribution with a uniform particle size and may achieve high transfer efficiency and uniform images.

1. A method of preparing a toner, which comprises the steps of:
preparing an aqueous dispersion medium containing calcium phosphate;
preparing a monomer mixture comprising a styrene-based pigment stabilizer having a weight average molecular weight of 2,000 to 200,000, a charge control agent, a pigment, and a monomer for binder resin;
dispersing the monomer mixture in a form of droplets in the aqueous dispersion medium; and
performing suspension polymerization for the monomer mixture dispersed in the form of droplets,
and the calcium phosphate is used in an amount of 2 to 6 parts by weight based on 100 parts by weight of the monomer mixture.

2. The method of claim 1, wherein the calcium phosphate is obtained by mixing a phosphate aqueous solution with a calcium salt aqueous solution.

3. The method of claim 2, further comprising adjusting pH of the aqueous dispersion medium to 4 to 7 by adding a water-soluble inorganic acid to pHosphate aqueous solution and then adding the calcium salt aqueous solution thereto.

4. The method of claim 1, wherein the styrene-based pigment stabilizer is one or more selected from the group consisting of styrene-butadiene-styrene, styrene-isoprene-styrene, styrene-ethylene-styrene, styrene-ethylene-butylene-styrene, styrene-ethylene-propylene-styrene, styrene-butadiene, styrene-isoprene, styrene-ethylene-butylene, and styrene-ethylene-propylene.

5. The method of claim 1, wherein the step of dispersing the monomer mixture in the form of droplets in the aqueous dispersion medium comprises mixing the monomer mixture and the aqueous dispersion medium to producing a mixed solution, and homogenizing the mixed solution at 5,000 to 20,000 rpm with a homogenizer.

6. The method of claim 1, further comprising washing produced toner particles to remove calcium phosphate and drying the toner particles, after suspension polymerization.

7. The method of claim 6, further comprising adjusting pH of a suspension polymerization solution to 2.0 or less, by adding a water-soluble inorganic acid to the solution, before washing.

8. The method of claim 1, wherein the monomer for binder resin is one or more selected from the group consisting of an aromatic vinylic monomer, an acrylate-based monomer, a methacrylate-based monomer, and a diene-based monomer.

9. The method of claim 1, wherein the pigment is one or more selected from the group consisting of a metal powder-type pigment, a metal oxide-type pigment, a carbon-type pigment, a sulfide-type pigment, a chromium salt-type pigment, a ferrocyanide-type pigment, an azo-type pigment, an acidic dye-type pigment, a basic dye-type pigment, a mordant dye-type pigment, phthalocyanin, a quinacridone-type pigment, and a dioxane-type pigment.

10. The method of claim 1, wherein the monomer mixture further comprises one or more additives selected from the group consisting of wax, a reaction initiator, a crosslinking agent, a lubricating agent, a molecular weight control agent, and a coupling agent.

11. The method of claim 10, wherein the wax is one or more selected from the group consisting of paraffin wax, microcrystalline wax, ceresin wax, carnauba wax, ester-based wax, polyethylene-based wax, and polypropylene-based wax.

12. The method of claim 10, wherein the reaction initiator is one or more selected from the group consisting of azobisisobutyronitrile, azobisvaleronitrile, benzoyl peroxide, lauroyl peroxide, potassium peroxide, and ammonium persulfate.

13. The method of claim 10, wherein the crosslinking agent is one or more selected from the group consisting of divinylbenzene, ethylene dimethacrylate, ethyleneglycol dimethacrylate, diethyleneglycol diacrylate, 1,6-hexamethylene diacrylate, allyl methacrylate, 1,1,1-trimethylolpropane triacrylate, triallylamine, and tetraallyloxyethane.

14. The method of claim 10, wherein the molecular weight control agent is one or more selected from the group consisting of t-dodecyl mercaptan, n-dodecyl mercaptan, n-octyl mercaptan, carbon tetrachloride, and carbon tetrabromide.

15. A polymerized toner prepared by the method according to claim 1.

16. The polymerized toner of claim 15, comprising, based on 100 parts by weight of a total amount of the polymerized toner, 0.1 to 20 parts by weight of a styrene-based pigment stabilizer having a weight average molecular weight of 2,000 to 20,000, 0.1 to 20 parts by weight of a charge control agent, 1 to 10 parts by weight of a pigment, and 0 to 30 parts by weight of wax.

17. The polymerized toner of claim 15, further comprising one or more selected from the group consisting of 0.1 to 10 parts by weight of a reaction initiator, 0.001 to 10 parts by weight of a crosslinking agent, and 0.001˜8 parts by weight of a molecular weight control agent, based on 100 parts by weight of a monomer for binder resin.
